(19) United States
(12) Patent Application Publication
(10) Pub. No.: US 2023/0091500 A1
(43) Pub. Date: Mar. 23, 2023

(54) DATA PROCESSING APPARATUS, SENDING APPARATUS, AND DATA PROCESSING METHOD

(71) Applicant: NEC Corporation, Minato-ku, Tokyo (JP)

(72) Inventors: Hiroki ITSUKAICHI, Tokyo (JP); Atsushi FUKUZATO, Tokyo (JP); Yasunori FUTATSUGI, Tokyo (JP); Daisuke WATANABE, Tokyo (JP); Yuichi YANAGIHARA, Tokyo (JP); Nobuo FUWA, Tokyo (JP)

(73) Assignee: NEC Corporation, Minato-ku, Tokyo (JP)

(21) Appl. No.: 17/801,475

(22) PCT Filed: Jan. 7, 2021
(86) PCT No.: PCT/JP2021/000332

§ 371 Date: Aug. 22, 2022

(30) Foreign Application Priority Data
Mar. 19, 2020 (JP) 2020-049889

(51) Int. Cl. H04N 7/18; G06T 7/70; G06T 7/20; G06V 20/58; G06V 20/52

(52) U.S. Cl. CPC H04N 7/181; G06T 7/70; G06T 7/20; G06V 20/58; G06V 20/52; G06T 2207/30261; G06T 2207/30232

(57) ABSTRACT

An image generation apparatus (20) includes an acquisition unit (210) and a data processing unit (220). The acquisition unit (210) repeatedly acquires analysis data from at least one sending apparatus (10). The analysis data include at least type data and relative position data. The data processing unit (220) generates, each time analysis data are acquired, a reconfigured image by using the analysis data, and causes a display (230) to display the reconfigured image. Further, the data processing unit (220) requests the sending apparatus (10) for a captured image, when a criterion is satisfied.

### TECHNICAL FIELD

The present invention relates to a data processing apparatus, a sending apparatus, a data processing method, and a program.

### BACKGROUND ART

In recent years, a configuration has been increasing in which various sensors such as a camera are loaded in a vehicle such as an automobile. For example, Patent Document 1 describes that a server acquires, from a plurality of vehicles including an own vehicle, detection results of these sensors, the server predicts an action of the own vehicle and another vehicle, the server performs a risk analysis by using the prediction result, and the server visualizes a possibility of a collision by augmented reality.

### RELATED DOCUMENT

### Patent Document

[Patent Document 1] Japanese Patent Application Publication No. 2020-9428

### DISCLOSURE OF THE INVENTION

### Technical Problem

Since enabling an image generated by an image capturing unit loaded in a vehicle to be checked in a surveillance center allows a surveillance person to visually check a state of the vicinity of the vehicle, it is possible to reduce a risk of traffic accident. On the other hand, sending an image as it is to the surveillance center increases an amount of communication.

As a method for suppressing the above, the inventors of the present invention studied that an image is analyzed in the vehicle, a result of the analysis is sent to a server in a surveillance center, and a state of the vicinity of the vehicle is visualized by means of the server with use of a result of the surveillance. However, it may be better for a surveillance person to directly check an image in order to improve quality of surveillance.

One of objects of the present invention is to improve quality of surveillance in a surveillance center, while suppressing an amount of communication between a vehicle and the surveillance center.

### Solution to Problem

A data processing apparatus according to an example aspect of the present invention includes:

an acquisition unit that repeatedly acquires analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

a data processing unit that requests the sending apparatus for the captured image, when a criterion is satisfied.

A sending apparatus loaded in a vehicle according to an example aspect of the present invention includes:

an image capturing unit that generates an image by capturing a vicinity of the vehicle;

an image processing unit that generates analysis data by processing the image, the analysis data including type data and relative position data, the type data indicating a kind of an object located in the vicinity of the vehicle, and the relative position data indicating a relative position of the object with respect to the vehicle; and

a communication unit that sends the analysis data to a data processing apparatus, and also sends the image to the data processing apparatus when the analysis data satisfy a criterion.

A data processing method according to an example aspect of the present invention includes:

by a computer,

acquisition processing of repeatedly acquiring analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

data processing of requesting the sending apparatus for the captured image, when a criterion is satisfied.

A program according to an example aspect of the present invention causes a computer to include:

an acquisition function of repeatedly acquiring analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

a data processing function of requesting the sending apparatus for the captured image, when a criterion is satisfied.

### Advantageous Effects of the Invention

The present invention enables improving quality of surveillance in a surveillance center, while suppressing an amount of communication between a vehicle and the surveillance center.

### BRIEF DESCRIPTION OF THE DRAWINGS

FIG. 1 is a diagram illustrating a usage environment of an image generation apparatus according to an example embodiment.

FIG. 2 is a diagram illustrating one example of a functional configuration of a sending apparatus.

FIG. 3 is a diagram illustrating one example of a functional configuration of the image generation apparatus.

FIG. 4 is a diagram illustrating a hardware configuration example of a main part of the sending apparatus.

FIG. 5 is a flowchart illustrating a first example of processing to be performed by the image generation apparatus.

FIG. 6 is a diagram illustrating a first example of a reconfigured image to be displayed on a display in step S50.

FIG. 7 is a diagram illustrating a second example of a reconfigured image to be displayed on the display in the step S50.

FIG. 8 is a flowchart illustrating a second example of processing to be performed by the image generation apparatus.

FIG. 9 is a flowchart illustrating a third example of processing to be performed by the image generation apparatus.

FIG. 10 is a flowchart illustrating a fourth example of processing to be performed by the image generation apparatus.

FIG. 11 is a flowchart illustrating a fifth example of processing to be performed by the image generation apparatus.

### DESCRIPTION OF EMBODIMENTS

In the following, an example embodiment according to the present invention is described with reference to the drawings. Note that, in all drawings, a similar constituent element is indicated by a similar reference sign, and description thereof is not repeated as necessary.

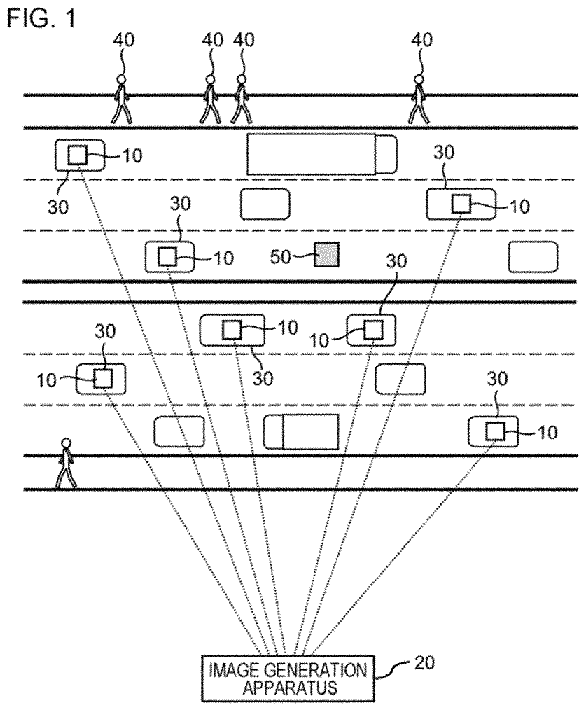

FIG. 1 is a diagram illustrating a usage environment of an image generation apparatus 20 according to an example embodiment. The image generation apparatus 20 is one example of a data processing apparatus, and is used together with a plurality of sending apparatuses 10. The image generation apparatus 20 is installed in a surveillance center. In the surveillance center, a surveillance person is surveying, for example, a road and a vehicle 30. Herein, the vehicle 30 may also be an autonomously driven vehicle.

The sending apparatus 10 is loaded in the vehicle 30, generates an image (photographed image) acquired by photographing the vicinity of the vehicle 30, for example, in front of the vehicle 30, and also sends, to the image generation apparatus 20, a result (hereinafter, described as analysis data) of processing the image. The analysis data include at least type data indicating a kind of an object located in the vicinity of the vehicle 30 (hereinafter, described as a first vehicle 30) in which the sending apparatus 10 is loaded, and relative position data indicating a relative position of the object with respect to the first vehicle 30. Herein, the object may be another vehicle 30 (hereinafter, described as a second vehicle 30), may be a pedestrian 40, may be a fallen object 50 present on a road, or may be a traffic sign disposed in the vicinity of a road or a road sign drawn on a road. Further, the image generation apparatus 20 generates a reconfigured image by using the analysis data, and displays the reconfigured image on a display. A position of an object within the reconfigured image is associated with a position where the object is present in a real space. Therefore, a surveillance person can visually recognize an environment of the vicinity of the first vehicle 30 by watching the reconfigured image.

Further, the image generation apparatus 20 requests the sending apparatus 10 for an image itself according to needs. As one example, in a case where a predetermined input from a user (e.g., a surveillance person) of the image generation apparatus 20 is present, the image generation apparatus 20 requests the sending apparatus 10 for an image. Then, the sending apparatus 10 sends the image to the image generation apparatus 20. In this case, the image generation apparatus 20 displays, on a display, the image generated by the sending apparatus 10. Thus, a user of the image generation apparatus 20 can directly check the image generated by the sending apparatus 10.

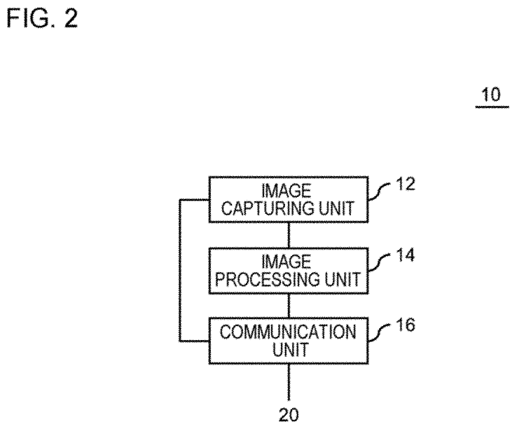

FIG. 2 is a diagram illustrating one example of a functional configuration of the sending apparatus 10. As described above, the sending apparatus 10 is loaded in a vehicle. In the example illustrated in FIG. 2, the sending apparatus 10 includes an image capturing unit 12, an image processing unit 14, and a communication unit 16. The image capturing unit 12 is, for example, an in-vehicle camera, and repeatedly photographs the vicinity of the first vehicle 30, for example, the vicinity (e.g., at least one of in front, by the side, and in back) of the first vehicle 30. The image capturing unit 12 may be a monocular camera, or may be a stereo camera. A framerate at this occasion is, for example, 10 frames per second or more, but is not limited thereto. Each time the image capturing unit 12 generates an image, the image processing unit 14 generates the above-described analysis data by processing the image. Each time the image processing unit 14 generates analysis data, the communication unit 16 sends the analysis data to the image generation apparatus 20. Further, when an image is requested from the image generation apparatus 20, the communication unit 16 sends, to the image generation apparatus 20, an image generated by the image capturing unit 12.

As described above, analysis data to be generated by the image processing unit 14 include type data indicating a kind of an object located in the vicinity of the first vehicle 30, and relative position data indicating a relative position of the object with respect to the first vehicle 30. The analysis data may include other pieces of data according to needs.

For example, analysis data may include data (hereinafter, described as road data) indicating a state of a road located in the vicinity (e.g., at least one of in front, by the side, and in back) of the first vehicle 30. Examples of a state of a road include, for example, a width, a state of extension, and a sign drawn on a road, but a state of a road is not limited thereto.

Further, in a case where an object is the second vehicle 30, analysis data may include relative velocity data. The relative velocity data indicate a relative velocity between the first vehicle 30 and the second vehicle 30. The relative velocity data are computed, for example, by using a change in a position of the second vehicle 30 between images, but may be generated by using an unillustrated sensor.

Note that, analysis data may indicate data indicating a difference with respect to analysis data sent in the past, for example, a difference with respect to type data and relative position data being indicated by analysis data sent in the past. Herein, a piece of “analysis data sent in the past” may be a piece of analysis data sent immediately before, or may be a piece of analysis data sent at a predetermined timing.

Further, the communication unit 16 may send, together with analysis data, information that discriminates the first vehicle 30 from another vehicle 30. Furthermore, the communication unit 16 may send, together with analysis data, other pieces of data related to the first vehicle 30. The other pieces of data include, for example, at least either one of data (hereinafter, described as vehicle position data) indicating a position of the first vehicle 30, and data (hereinafter, described as vehicle velocity data) indicating velocity of the first vehicle 30. Herein, vehicle position data are generated, for example, by using a GPS, and vehicle velocity data are generated by using a velocimeter loaded in the first vehicle 30.

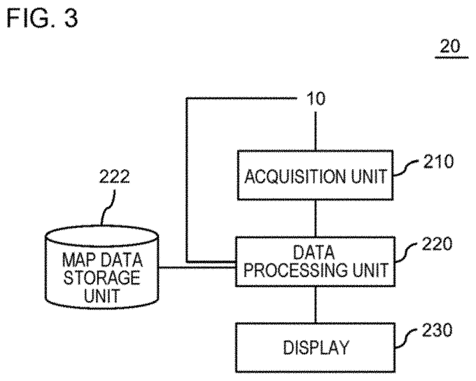

FIG. 3 is a diagram illustrating one example of a functional configuration of the image generation apparatus 20. In the example illustrated in FIG. 3, the image generation apparatus 20 includes an acquisition unit 210, a data processing unit 220, and a display 230. The acquisition unit 210 repeatedly acquires analysis data from at least one of the sending apparatuses 10. As described above, the analysis data include at least type data and relative position data. Each time the data processing unit 220 acquires analysis data, the data processing unit 220 generates a reconfigured image by using the analysis data, and causes the display 230 to display the reconfigured image. Herein, the display 230 may be located on the outside of the image generation apparatus 20. In this case, the image generation apparatus 20 is achieved by a cloud server, and the display 230 can be disposed in a surveillance center. A reconfigured image includes an indication based on type data at a position associated with relative position data. The indication may be a mark imitating an outer shape of a kind indicated by the type data, or may be a symbolized mark.

Further, in a case where analysis data include the above-described road data, the data processing unit 220 may include, in a reconfigured image, an indication of a road according to the road data. In this case, the data processing unit 220 reproduces a road on which the first vehicle 30 is traveling in a reconfigured image, and also reproduces an object located in the vicinity of the first vehicle 30 in the reconfigured image. Specifically, a reconfigured image becomes an image that reproduces the vicinity of the first vehicle 30.

Further, in a case where analysis data include the above-described relative velocity data, and the acquisition unit 210 acquires vehicle velocity data together with the analysis data, the data processing unit 220 may estimate velocity of the second vehicle 30 by using the vehicle velocity data and the relative velocity data, and may include, in a reconfigured image, an indication indicating the estimation result, or may display the indication together with the reconfigured image. The estimation result may be displayed, for example, near the second vehicle 30 for which the estimation is performed, or may be displayed in a form of a list.

Note that, the data processing unit 220 may use information stored in a map data storage unit 222 at a time of generating a reconfigured image. The map data storage unit 222 stores map data in association with position information. Further, the acquisition unit 210 acquires, together with analysis data, the above-described vehicle position data. Further, the data processing unit 220 acquires, from the map data storage unit 222, map data including a location associated with vehicle position data. The map data include at least a width and a shape of a road. Further, the data processing unit 220 includes, in a reconfigured image, a road based on the map data. The road is at least the one acquired by reproducing a road on which the vehicle 30 is traveling.

Note that, the map data storage unit 222 may be a part of the image generation apparatus 20, or may be located on the outside of the image generation apparatus 20.

Further, the data processing unit 220 may request the sending apparatus 10 for an image generated by the image capturing unit 12, when a criterion is satisfied. In this case, the data processing unit 220 causes the display 230 to display an image acquired from the sending apparatus 10. Note that, the criterion may be defined, for example, regarding analysis data, or may be defined regarding an input to the image generation apparatus 20 by a user (surveillance person). A specific example of the criterion will be described later by using another diagram.

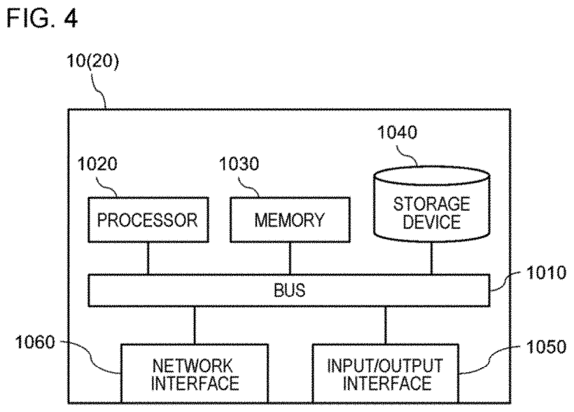

FIG. 4 is a diagram illustrating a hardware configuration example of a main part of the sending apparatus 10. The sending apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually send and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (e.g., the image processing unit 14 and the communication unit 16) of the sending apparatus 10. The processor 1020 achieves each function associated with each program module by reading each of these program modules in the memory 1030 and executing each of these program modules.

The input/output interface 1050 is an interface for connecting the main part of the sending apparatus 10 and various types of input/output equipment each other. For example, the main part of the sending apparatus 10 communicates with the image capturing unit 12 via the input/output interface 1050.

The network interface 1060 is an interface for connecting the sending apparatus 10 to a network. The network is, for example, a local area network (LAN) or a wide area network (WAN). A method of connecting the network interface 1060 to a network may be wireless connection or may be wired connection. The sending apparatus 10 communicates with the image generation apparatus 20 via the network interface 1060.

Note that, a hardware configuration example of the image generation apparatus 20 is also as illustrated in FIG. 4. In this case, the storage device 1040 stores a program module that achieves a function (e.g., the acquisition unit 210 and the data processing unit 220) of the image generation apparatus 20. Further, the storage device 1040 also functions as the map data storage unit 222.

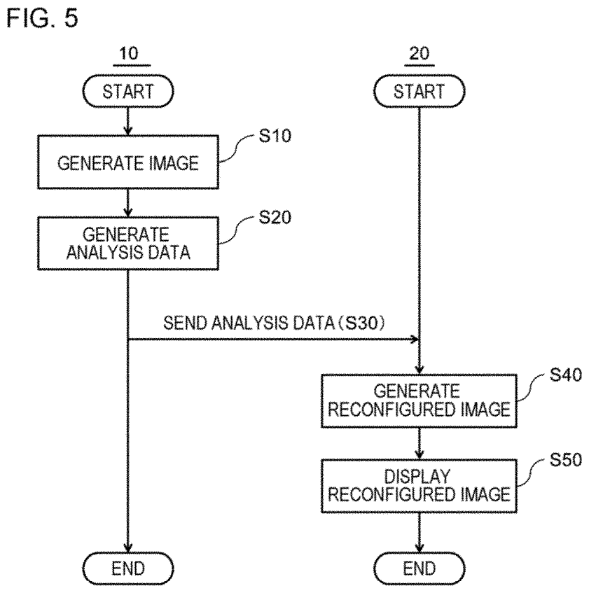

FIG. 5 is a flowchart illustrating a first example of processing to be performed by the image generation apparatus 20 together with processing to be performed by the sending apparatus 10. The sending apparatus 10 and the image generation apparatus 20 perform processing illustrated in FIG. 5, each time the image capturing unit 12 of the sending apparatus 10 generates an image.

When the image capturing unit 12 generates an image (step S10), the image processing unit 14 of the sending apparatus 10 generates analysis data by processing the image (step S20). Subsequently, the communication unit 16 of the sending apparatus 10 sends, to the image generation apparatus 20, the analysis data generated in the step S20. At this occasion, the communication unit 16 sends, together with the analysis data, relative velocity data and vehicle velocity data of the first vehicle 30 (step S30).

The acquisition unit 210 of the image generation apparatus 20 acquires data sent from the sending apparatus 10. Then, the data processing unit 220 of the image generation apparatus 20 generates a reconfigured image by using the data acquired by the acquisition unit 210 (step S40), and causes the display 230 to display the reconfigured image (step S50).

Note that, processing described in the step S20 and thereafter may be performed only for a part of an image generated by the image capturing unit 12. For example, in the step S10, the image capturing unit 12 may perform photographing at a framerate (e.g., 24 frames per second or more) of an ordinary moving image, and processing in the step S20 and thereafter may be performed at a framerate (e.g., 12 frames per second), which is lower than that of the image capturing unit 12.

Further, a frequency with which processing indicated in the step S20 and thereafter is performed may be changed according to velocity of the first vehicle 30. As one example, as velocity of the first vehicle 30 increases, the frequency increases. By doing so, load on the sending apparatus 10 and the image generation apparatus 20 decreases, when velocity of the first vehicle 30 is low.

Note that, in the step S30, the communication unit 16 may send, to the image generation apparatus 20, only a part of pieces of analysis data generated in the step S20. For example, the communication unit 16 may send, to the image generation apparatus 20, only pieces of data related to the second vehicle 30 and a traffic sign. In this case, the data processing unit 220 of the image generation apparatus 20 requests the sending apparatus 10 for all pieces of analysis data according to needs. One example is a case that a predetermined input from a surveillance person is present. Then, thereafter, the communication unit 16 of the sending apparatus 10 sends, to the image generation apparatus 20, all pieces of analysis data (e.g., a piece of data related to the fallen object 50 on a road). By doing so, an amount of communication between the sending apparatus 10 and the image generation apparatus 20 decreases.

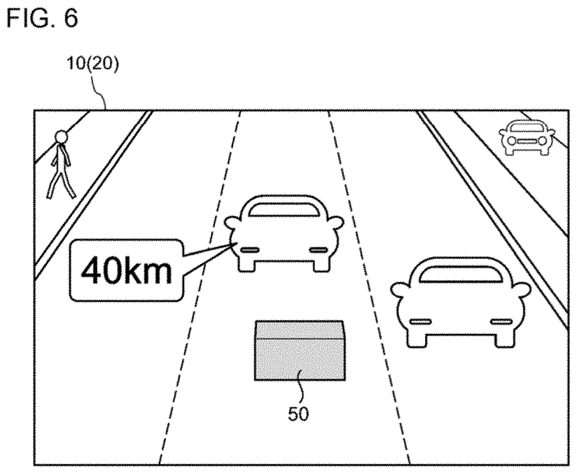

FIG. 6 illustrates a first example of a reconfigured image to be displayed on the display 230 in the step S50. In the example illustrated in FIG. 6, the data processing unit 220 generates, as a reconfigured image, an image in which an outside of the first vehicle 30 is viewed from the first vehicle 30. As one example, the reconfigured image becomes an image viewed from a driver's seat of the first vehicle 30. For example, in a case where the first vehicle 30 is traveling on a road including a plurality of lanes on one way, the second vehicle 30 and a traffic sign located in front (including obliquely in front) of the first vehicle 30 are displayed in a reconfigured image. Further, in a case where the fallen object 50 is present on a road, the fallen object 50 is also displayed in the reconfigured image. Furthermore, in a case where a pedestrian is present in the vicinity of the first vehicle 30, the pedestrian is also displayed in the reconfigured image.

Further, in the example illustrated in FIG. 6, velocity of the second vehicle 30 is also displayed in the reconfigured image. The velocity is computed by using relative velocity data and vehicle velocity data.

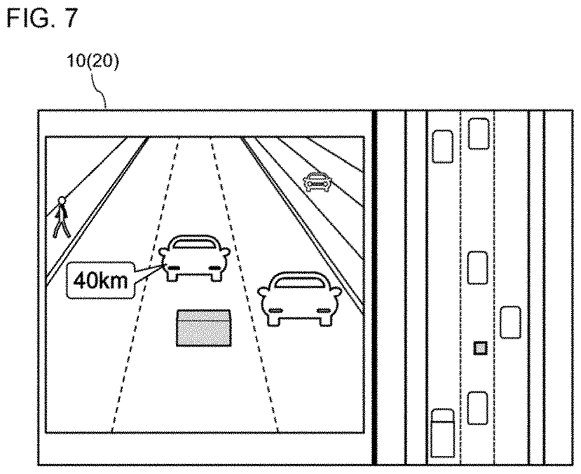

FIG. 7 illustrates a second example of a reconfigured image to be displayed on the display 230 in the step S50. In the example illustrated in FIG. 7, a reconfigured image includes a bird's eye view, in addition to the image illustrated in FIG. 6. Note that, the reconfigured image may only be a bird's eye view. Note that, in a case where analysis data are related to a plurality of directions of the first vehicle 30, it is easy to generate a bird's eye view as a reconfigured image.

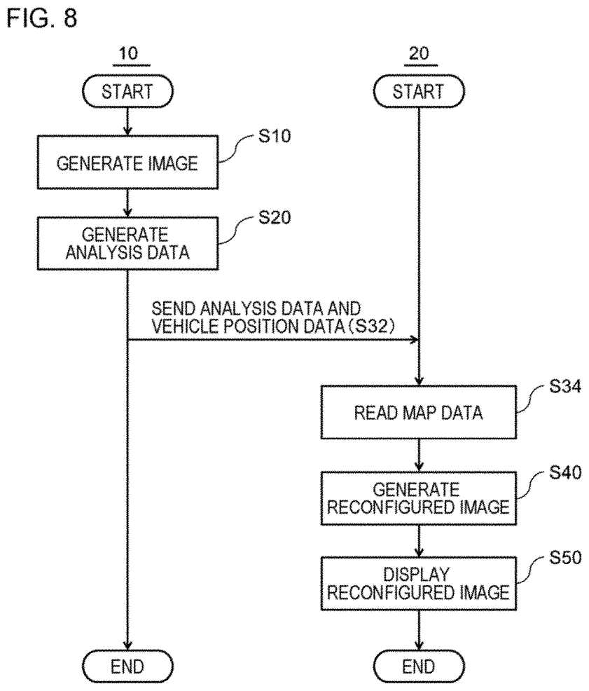

FIG. 8 is a flowchart illustrating a second example of processing to be performed by the image generation apparatus 20 together with processing to be performed by the sending apparatus 10. Processing illustrated in FIG. 8 is similar to processing illustrated in FIG. 5 except for a point that map data are used when a reconfigured image is generated. Further, in the example illustrated in FIG. 8, analysis data may not include road data.

After step S20, the communication unit 16 of the sending apparatus 10 sends, to the image generation apparatus 20, vehicle position data together with analysis data. At this occasion, the communication unit 16 sends, together with the analysis data, relative velocity data and vehicle velocity data of the first vehicle 30 (step S32).

When the acquisition unit 210 of the image generation apparatus 20 acquires data sent from the sending apparatus 10, the data processing unit 220 reads, from the map data storage unit 222, map data including a location indicated by vehicle position data (step S34), generates a reconfigured image by using the map data (step S40), and causes the display 230 to display the generated reconfigured image (step S50).

Since using map data makes it unnecessary to generate road data in the image processing unit 14 of the sending apparatus 10, processing load of the image processing unit 14 decreases.

Note that, the data processing unit 220 may generate a first reconfigured image by a method illustrated in FIG. 5, and also generate a second reconfigured image by a method illustrated in FIG. 8. In this case, the data processing unit 220 may cause the display 230 to display the first reconfigured image and the second reconfigured image in a comparable state. For example, the data processing unit 220 may cause the display 230 to display the first reconfigured image and the second reconfigured image side by side, or cause the display 230 to display the first reconfigured image and the second reconfigured image in a superimposed manner. By doing so, a surveillance person can visually recognize a difference (as one example, an anomaly that has occurred on a road) between map data and road data generated by the image processing unit 14 of the sending apparatus 10.

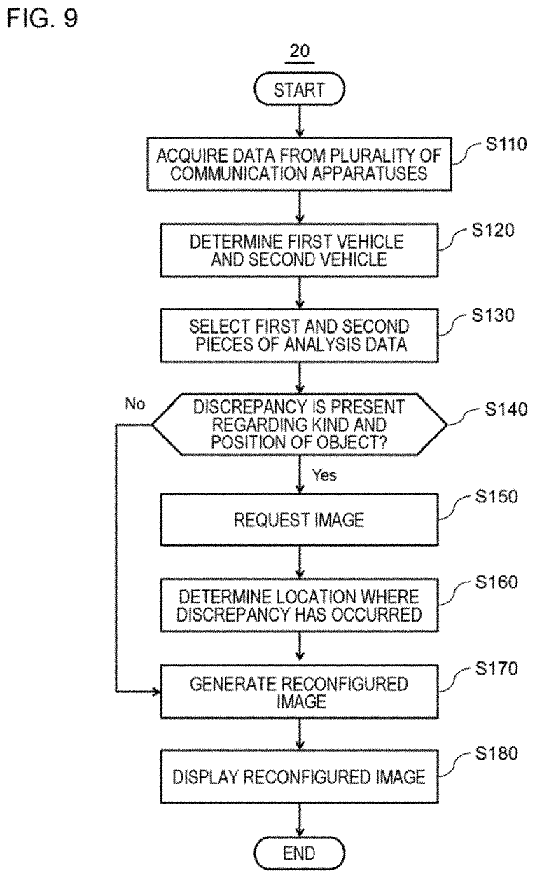

FIG. 9 illustrates a third example of processing to be performed by the image generation apparatus 20. In processing illustrated in FIG. 9, the sending apparatus 10 is loaded in a plurality of vehicles 30. Further, the sending apparatus 10 performs processing illustrated in FIG. 5 or 8.

The acquisition unit 210 of the image generation apparatus 20 acquires, from a plurality of the sending apparatuses 10, analysis data, vehicle position data, vehicle velocity data, and relative velocity data (step S110).

Subsequently, the data processing unit 220 acquires information that determines the vehicle 30 (equivalent to the above-described first vehicle 30) being a target from among the plurality of vehicles 30. The acquisition may be performed, for example, by an input from a surveillance person. Then, the data processing unit 220 determines, as the second vehicle 30, a vehicle 30 located near the first vehicle 30 by using the vehicle position data. As one example, the data processing unit 220 acquires a piece of vehicle position data associated with the first vehicle 30, determines at least one other piece of the vehicle position data whose correlation (e.g., a direction and a distance) with respect to the piece of vehicle position data satisfies a criterion, and sets the vehicle 30 associated with the one other piece of the vehicle position data, as the second vehicle 30. Herein, in a case where a plurality of vehicles 30 are determined, the data processing unit 220 sets these plurality of vehicles 30, as the second vehicle 30 (step S120).

Subsequently, the data processing unit 220 acquires a piece of analysis data (hereinafter, described as a first piece of analysis data) associated with the first vehicle 30, and also selects a piece of analysis data (hereinafter, described as a second piece of analysis data) associated with the second vehicle 30 (step S130). Subsequently, the data processing unit 220 determines whether a discrepancy is present between the first piece of analysis data and the second piece of analysis data. As one example, the data processing unit 220 determines whether a discrepancy is present between a kind and a position of an object indicated by the first piece of analysis data, and a kind and a position of an object indicated by the second piece of analysis data (step S140).

For example, the data processing unit 220 determines a position for each object by using position information of the first vehicle 30 and a first piece of analysis data. Likewise, the data processing unit 220 determines a position for each object by using position information of the second vehicle 30 and a second piece of analysis data. Further, the data processing unit 220 determines whether a discrepancy is present between these positions for each object. As one example of a discrepancy, there is a case that an object being present in one analysis result is not present in the other analysis result. Further, as another example of a discrepancy, there is a case that a position of an object indicated by one analysis result, and a position of an object indicated by the other analysis result differ by a value equal to or more than a criterion value.

Further, in a case where a discrepancy is present (step S140: Yes), the data processing unit 220 requests at least either one of the sending apparatus 10 of the first vehicle 10, and the sending apparatus 10 of the second vehicle 30 to send an image (step S150). Thereafter, the sending apparatus 10 sends, to the image generation apparatus 20, an image generated by the image capturing unit 12 together with analysis data, or in place of analysis data. Then, the data processing unit 220 causes the display 230 to display the image. Note that, the data processing unit 220 may display the image and a reconfigured image side by side.

Further, when the data processing unit 220 determines a position (specifically, a location) of an object where a discrepancy has occurred (step S160), the data processing unit 220 generates a reconfigured image in such a way as to include an indication indicating the determined location (step S170), and causes the display 230 to display the generated reconfigured image (step S180). Another indication included in the reconfigured image is as illustrated in FIG. 6 or 7. Herein, in a case where a discrepancy has occurred, the data processing unit 220 may perform a predetermined output such as, for example, an alarm indication.

On the other hand, in a case where no discrepancy is present in the step S140 (step S140: No), the data processing unit 220 generates a reconfigured image (step S170), and causes the display 230 to display the generated reconfigured image (step S180). A reconfigured image to be generated herein is similar to the above-described reconfigured image except for a point that an indication indicating a location where a discrepancy has occurred is not included.

Note that, in any case, in the step S170, the data processing unit 220 generates a reconfigured image by using a first piece of analysis data, and at least one second piece of analysis data. For example, the data processing unit 220 determines a position for each object by using position information of the first vehicle 30 and a first piece of analysis data. Likewise, the data processing unit 220 determines a position for each object by using position information of the second vehicle 30 and a second piece of analysis data. Further, the data processing unit 220 generates a bird's eye view by using these determination results. By doing so, it is possible to determine presence of an object within a range that cannot be covered by the first piece of analysis data by using the second piece of analysis data, and include, in a reconfigured image, an indication indicating the object, together with an indication indicating an object determined by the first piece of analysis data.

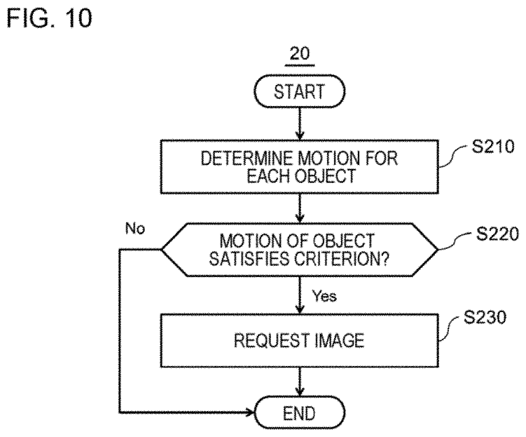

FIG. 10 illustrates a fourth example of processing to be performed by the image generation apparatus 20. Processing illustrated in FIG. 10 is performed in parallel to processing illustrated in FIG. 5, 8, or 9, each time the image generation apparatus 20 acquires analysis data.

First, the data processing unit 220 determines a motion of an object for each detected object by using analysis data sent from the sending apparatus 10 of the first vehicle 30. For example, the data processing unit 220 determines a motion of an object by using a difference between a piece of analysis data acquired at this time, and a piece of analysis data acquired a while ago (step S210). Further, the data processing unit 220 determines whether the motion of the object determined in the step S210 satisfies a criterion defined for each object (step S220).

For example, in a case where an object is a pedestrian, the criterion is that the pedestrian is moving toward a roadway. Further, in a case where an object is the second vehicle 30, the criterion is a case that a relative position of the second vehicle 30 with respect to the first vehicle 30, or a change of the relative position is determined to be anomalous. Specific examples of the case include a case that the second vehicle 30 is an oncoming vehicle, and a case that an oncoming vehicle is moving at an improbable velocity. Note that, determination as to an anomaly is performed by using, for example, a model generated by machine learning. Further, in a case where analysis data include an error, a change of the above-described relative position may indicate a physically improbable behavior. The data processing unit 220 also determines that the above case is anomalous.

In the step S220, in a case where the criterion is satisfied (step S220: Yes), the data processing unit 220 requests the sending apparatus 10 of the first vehicle 30 to send an image (step S230). Thereafter, the sending apparatus 10 sends, to the image generation apparatus 20, an image generated by the image capturing unit 12 together with analysis data, or in place of analysis data. Then, the data processing unit 220 causes the display 230 to display the image. Note that, the data processing unit 220 may display the image and a reconfigured image side by side.

Note that, the communication unit 16 of the sending apparatus 10 may determine whether analysis data satisfies a criterion, in place of the image generation apparatus 20. One example of the determination is processing indicated in the steps S210 and S220 in FIG. 10. Further, another example of the determination is a case that reliability (e.g., a score when an object is detected) of analysis data does not satisfy a criterion. Further, in a case where analysis data satisfy a criterion, the communication unit 16 sends, to the image generation apparatus 20, an image generated by the image capturing unit 12 together with analysis data or in place of analysis data.

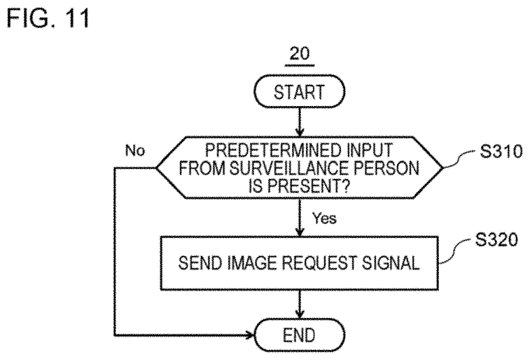

FIG. 11 illustrates a fourth example of processing to be performed by the image generation apparatus 20. Processing illustrated in FIG. 11 is performed in parallel to processing illustrated in FIG. 5, 8, or 9, and processing illustrated in FIG. 10.

In the example illustrated in FIG. 11, a surveillance person using the image generation apparatus 20 checks a reconfigured image. Further, when a surveillance person determines that it is better to directly check an image generated by the image capturing unit 12 of the sending apparatus 10, the surveillance person performs a predetermined input to the image generation apparatus 20 (step S310: Yes). Examples of a case as described above include, for example, a case that an anomaly has occurred regarding a motion of any one of the vehicles 30, and a case that vehicles 30 in various directions are included in a reconfigured image in a bird's eye view. Examples of the former example include a case that a fallen object 50 that cannot be captured by image processing is present, and a case that a road construction is being performed. Then, the data processing unit 220 requests the sending apparatus 10 of the first vehicle 30 to send an image (step S320). Processing to be performed thereafter is as described with reference to FIG. 10.

As described above, according to the present example embodiment, the sending apparatus 10 sends, to the image generation apparatus 20, analysis data being an analysis result of an image, in place of the image. The analysis data include at least type data indicating a kind of an object located in the vicinity of a vehicle 30, and relative position data indicating a relative position of the object with respect to the vehicle 30. Further, the data processing unit 220 of the image generation apparatus 20 generates a reconfigured image by using the analysis data, and causes the display 230 to display the reconfigured image. Therefore, a surveillance person can check the object being present in the vicinity of the vehicle 30. Further, as compared with a case where the sending apparatus 10 sends an image to the image generation apparatus 20, an amount of communication between the sending apparatus 10 and the image generation apparatus 20 decreases.

Further, the image generation apparatus 20 requests the sending apparatus 10 for an image, when a criterion is satisfied. Then, the sending apparatus 10 sends the image to the image generation apparatus 20. The data processing unit 220 of the image generation apparatus 20 causes the display 230 to display the image acquired from the sending apparatus 10. In this way, the image generation apparatus 20 causes the display 230 to display an image generated by the image capturing unit 12, when needed. Therefore, it is possible to improve quality of surveillance by a surveillance person.

As described above, an example embodiment according to the present invention has been described with reference to the drawings, however, these are an example of the present invention, and various configurations other than the above can also be adopted.

Further, in a plurality of flowcharts used in the above description, a plurality of steps (pieces of processing) are described in order, however, an order of execution of steps to be performed in each example embodiment is not limited to the order of description. In each example embodiment, the order of illustrated steps can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. A data processing apparatus including:

an acquisition unit that repeatedly acquires analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

a data processing unit that requests the sending apparatus for the captured image, when a criterion is satisfied.

2. The data processing apparatus according to supplementary note 1, in which

the criterion is defined regarding the analysis data.

3. The data processing apparatus according to supplementary note 2, in which

a motion of the object is defined for each kind of the object as the criterion, and

the data processing unit determines a motion of the object for each object by using a plurality of pieces of the analysis data, and requests the captured image, when the motion satisfies the criterion associated with a kind of the object.

4. The data processing apparatus according to supplementary note 2, in which

the acquisition unit acquires vehicle position data together with the analysis data from each of a plurality of the vehicles, the vehicle position data indicating a position of the vehicle,

the data processing unit, when acquiring information that determines one piece of the vehicle position data,
acquires a first piece of the analysis data associated with the one piece of the vehicle position data,
acquires at least one other piece of the vehicle position data whose correlation with respect to the one piece of the vehicle position data satisfies a criterion, and acquires a second piece of the analysis data associated with the at least one other piece of the vehicle position data, and,
when a discrepancy has occurred between a kind and a position of the object indicated by the first piece of the analysis data, and a kind and a position of the object indicated by the second piece of the analysis data, requests the sending apparatus for the captured image, the sending apparatus being loaded in the vehicle associated with the one piece of the vehicle position data.
   5. The data processing apparatus according to supplementary note 1, in which

the criterion is that a predetermined user input is present.

6. The data processing apparatus according to any one of supplementary notes 1 to 5, in which

the data processing unit requests the captured image, in place of the analysis data.

7. The data processing apparatus according to supplementary note 6, in which

the data processing unit
generates an image including an indication based on the type data at a position associated with the relative position data, and causes a display to display the generated image, each time the analysis data are acquired, and
causes the display to display the captured image, each time the captured image is received.
   8. A sending apparatus loaded in a vehicle, including:

an image processing unit that generates analysis data by processing an image acquired by capturing a vicinity of the vehicle, the analysis data including type data and relative position data, the type data indicating a kind of an object located in the vicinity of the vehicle, and the relative position data indicating a relative position of the object with respect to the vehicle; and

a communication unit that sends the analysis data to a data processing apparatus, and also sends the image to the data processing apparatus when the analysis data satisfy a criterion.

9. The sending apparatus according to supplementary note 8, in which

a motion of the object is defined for each kind of the object as the criterion, and

the communication unit determines a motion of the object for each object by using a plurality of pieces of the analysis data, and sends the image to the data processing apparatus when the motion satisfies the criterion associated with a kind of the object.

10. The sending apparatus according to supplementary note 8 or 9, in which

the communication unit sends the captured image, in place of the analysis data.

11. A data processing method of performing:

by a computer,

acquisition processing of repeatedly acquiring analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

data processing of requesting the sending apparatus for the captured image, when a criterion is satisfied.

12. The data processing method according to supplementary note 11, in which

the criterion is defined regarding the analysis data.

13. The data processing method according to supplementary note 12, in which

a motion of the object is defined for each kind of the object as the criterion,

the data processing method further including,

by the computer,

determining a motion of the object for each object by using a plurality of pieces of the analysis data, and requesting the captured image when the motion satisfies the criterion associated with a kind of the object.

14. The data processing method according to supplementary note 12, further including:

by the computer,

acquiring vehicle position data together with the analysis data from each of a plurality of the vehicles, the vehicle position data indicating a position of the vehicle;

when acquiring information that determines one piece of the vehicle position data,
acquiring a first piece of the analysis data associated with the one piece of the vehicle position data;
acquiring at least one other piece of the vehicle position data whose correlation with respect to the one piece of the vehicle position data satisfies a criterion, and acquiring a second piece of the analysis data associated with the at least one other piece of the vehicle position data; and,
when a discrepancy has occurred between a kind and a position of the object indicated by the first piece of the analysis data, and a kind and a position of the object indicated by the second piece of the analysis data, requesting the sending apparatus for the captured image, the sending apparatus being loaded in the vehicle associated with the one piece of the vehicle position data.
   15. The data processing method according to supplementary note 11, in which

the criterion is that a predetermined user input is present.

16. The data processing apparatus according to any one of supplementary notes 11 to 15, further including,

by the computer,

requesting the captured image, in place of the analysis data.

17. The data processing method according to supplementary note 16, further including:

by the computer,

generating an image including an indication based on the type data at a position associated with the relative position data, and causes a display to display the generated image, each time the analysis data are acquired; and

causing the display to display the captured image, each time the captured image is received.

18. A sending method including:

by a computer loaded in a vehicle,

generating analysis data by processing an image acquired by capturing a vicinity of the vehicle, the analysis data including type data and relative position data, the type data indicating a kind of an object located in the vicinity of the vehicle, and the relative position data indicating a relative position of the object with respect to the vehicle; and

sending the analysis data to a data processing apparatus, and also sending the image to the data processing apparatus when the analysis data satisfy a criterion.

19. The sending method according to supplementary note 18, in which

a motion of the object is defined for each kind of the object as the criterion,

the sending method further including,

by the computer,

determining a motion of the object for each object by using a plurality of pieces of the analysis data, and sending the image to the data processing apparatus when the motion satisfies the criterion associated with a kind of the object.

21. A program causing a computer to include:

an acquisition function of repeatedly acquiring analysis data from a sending apparatus loaded in a vehicle, the analysis data being a result of processing a captured image generated by an image capturing unit loaded in the vehicle, and the analysis data including type data and relative position data, the type data indicating a kind of an object located in a vicinity of the vehicle, and the relative position data indicating a relative position of the object with respect to the vehicle; and

a data processing function of requesting the sending apparatus for the captured image, when a criterion is satisfied.

22. The program according to supplementary note 21, in which

the criterion is defined regarding the analysis data.

23. The program according to supplementary note 22, in which

a motion of the object is defined for each kind of the object as the criterion, and

the data processing function determines a motion of the object for each object by using a plurality of pieces of the analysis data, and requests the captured image when the motion satisfies the criterion associated with a kind of the object.

24. The program according to supplementary note 22, in which

the acquisition function acquires vehicle position data together with the analysis data from each of a plurality of the vehicles, the vehicle position data indicating a position of the vehicle,

the data processing function, when acquiring information that determines one piece of the vehicle position data,
acquires a first piece of the analysis data associated with the one piece of the vehicle position data,
acquires at least one other piece of the vehicle position data whose correlation with respect to the one piece of the vehicle position data satisfies a criterion, and acquires a second piece of the analysis data associated with the at least one other piece of the vehicle position data, and,
when a discrepancy has occurred between a kind and a position of the object indicated by the first piece of the analysis data, and a kind and a position of the object indicated by the second piece of the analysis data, requests the sending apparatus for the captured image, the sending apparatus loaded in the vehicle associated with the one piece of the vehicle position data.
   25. The program according to supplementary note 21, in which

the criterion is that a predetermined user input is present.

26. The program according to any one of supplementary notes 21 to 25, in which

the data processing function requests the captured image, in place of the analysis data.

27. The program according to supplementary note 26, in which

the data processing function
generates an image including an indication based on the type data at a position associated with the relative position data, and causes a display to display the generated image, each time the analysis data are acquired, and
causes the display to display the captured image, each time the captured image is received.
   28. A program causing a computer loaded in a vehicle to include:

an image processing function of generating analysis data, by processing an image acquired by capturing a vicinity of the vehicle, the analysis data including type data and relative position data, the type data indicating a kind of an object located in the vicinity of the vehicle, and the relative position data indicating a relative position of the object with respect to the vehicle; and

a sending function of sending the analysis data to a data processing apparatus, and also sending the image to the data processing apparatus when the analysis data satisfy a criterion.

29. The sending method according to supplementary note 28, in which

a motion of the object is defined for each kind of the object as the criterion, and

the sending function determines a motion of the object for each object by using a plurality of pieces of the analysis data, and sends the image to the data processing apparatus when the motion satisfies the criterion associated with a kind of the object.

30. The program according to supplementary note 28 or 29, in which

the sending function sends the captured image, in place of the analysis data.

This application is based upon and claims the benefit of priority from Japanese patent application No. 2020-049889, filed on Mar. 19, 2020, the disclosure of which is incorporated herein in its entirety by reference.

### REFERENCE SIGNS LIST

10 Sending apparatus
12 Image capturing unit
14 Image processing unit
16 Communication unit
20 Image generation apparatus
210 Acquisition unit
220 Data processing unit
222 Map data storage unit
230 Display

What is claimed is:

1. A data processing apparatus comprising:
at least one memory configured to store instructions; and
at least one processor configured to execute the instructions to perform operations comprising:
repeatedly acquiring analysis data from a sending apparatus loaded in a vehicle, the analysis data being a result of processing a captured image generated by an image sensor loaded in the vehicle, and the analysis data including type data and relative position data, the type data indicating a kind of an object located in a vicinity of the vehicle, and the relative position data indicating a relative position of the object with respect to the vehicle; and
requesting the sending apparatus for the captured image, when a criterion is satisfied.

2. The data processing apparatus according to claim 1, wherein
the criterion is defined regarding the analysis data.

3. The data processing apparatus according to claim 2, wherein
a motion of the object is defined for each kind of the object as the criterion, and
the operations comprise:
determining a motion of the object for each object by using a plurality of pieces of the analysis data; and
requesting the captured image when the motion satisfies the criterion associated with a kind of the object.

4. The data processing apparatus according to claim 2, wherein the operations comprise:
acquiring vehicle position data together with the analysis data from each of a plurality of the vehicles, the vehicle position data indicating a position of the vehicle;
when acquiring information that determines one piece of the vehicle position data,
acquiring a first piece of the analysis data associated with the one piece of the vehicle position data,
acquiring at least one other piece of the vehicle position data whose correlation with respect to the one piece of the vehicle position data satisfies a criterion, and
acquiring a second piece of the analysis data associated with the at least one other piece of the vehicle position data; and,
when a discrepancy has occurred between a kind and a position of the object indicated by the first piece of the analysis data, and a kind and a position of the object indicated by the second piece of the analysis data, requesting the sending apparatus for the captured image, the sending apparatus being loaded in the vehicle associated with the one piece of the vehicle position data.

5. The data processing apparatus according to claim 1, wherein
the criterion is that a predetermined user input is present.

6. The data processing apparatus according to claim 1, wherein the operations comprise
requesting the captured image, in place of the analysis data.

7. The data processing apparatus according to claim 6, wherein the operations comprise:
generating an image including an indication based on the type data at a position associated with the relative position data;
causing a display to display the generated image, each time the analysis data are acquired; and
causing the display to display the captured image, each time the captured image is received.

8. A sending apparatus loaded in a vehicle, comprising:
at least one memory configured to store instructions; and
at least one processor configured to execute the instructions to perform operations comprising:
generating analysis data by processing an image acquired by capturing a vicinity of the vehicle, the analysis data including type data and relative position data, the type data indicating a kind of an object located in the vicinity of the vehicle, and the relative position data indicating a relative position of the object with respect to the vehicle; and
sending the analysis data to a data processing apparatus, and also sending the image to the data processing apparatus when the analysis data satisfy a criterion.

9. A data processing method executed by a computer, the data processing method comprising:
repeatedly acquiring analysis data from a sending apparatus loaded in a vehicle, the analysis data being a result of processing a captured image generated by an image sensor loaded in the vehicle, and the analysis data including type data and relative position data, the type data indicating a kind of an object located in a vicinity of the vehicle, and the relative position data indicating a relative position of the object with respect to the vehicle; and
requesting the sending apparatus for the captured image, when a criterion is satisfied.

10. (canceled)
